(19) United States
(12) Patent Application Publication
(10) Pub. No.: US 2019/0113054 A1
(43) Pub. Date: Apr. 18, 2019

(54) EXPANSION TANK WITH DECOUPLED SINGLE FLEXIBLE DIAPHRAGM

(71) Applicant: FLEXCON INDUSTRIES, INC., Randolph, MA (US)

(72) Inventors: Thomas W. Wideman, Milton, MA (US); Lucas Murphy, North Easton, MA (US); Travis Bergmiller, Taunton, MA (US); Anthony Palaza, Pembroke, MA (US)

(73) Assignee: FLEXCON INDUSTRIES, INC., Randolph, MA (US)

(21) Appl. No.: 16/089,728

(22) PCT Filed: Mar. 30, 2017
(86) PCT No.: PCT/US2017/025098

§ 371 Date: Sep. 28, 2018

Related U.S. Application Data
(60) Provisional application No. 62/357,028, filed on Jun. 30, 2016.
(60) Provisional application No. 62/316,445, filed on Mar. 31, 2016.

(51) Int. Cl. F15B 1/14; F15B 1/10

(52) U.S. Cl. CPC F15B 1/14; F15B 1/106; F15B 2201/4155; F15B 2201/3156; F15B 2201/205; F15B 2201/3151

(57) ABSTRACT

An expansion tank with an improved diaphragm seal includes a seal for the joint between the flexible diaphragm and either an optional. non-flexible diaphragm or the tank wall, the providing of a seal support that prevents collapse, delamination, or tearing of the 5 tank shell wall. The tank shell may be formed of two substantially hemispherical domes joined together, either directly or at the two ends of a substantially cylindrical section. One of the segments forming the shell of the expansion tank, further comprises an extension lip, extending inwardly of the tank and around the entire circumference of the inner surface of the shell wall, located substantially near the junction of two of the sections 10 forming the tank. This extension lip may be made from the same material as the tank wall, or may be part of a separate circumferential connector interconnecting two of the sections of the tank wall.

### BACKGROUND OF THE INVENTION

Expansion tanks are known for use in flow systems for controlling flow of liquid under varying pressures. Generally, expansion tanks comprise a substantially cylindrical housing terminated on each end by a substantially hemispherical or isotensoidal dome. In some cases, the cylindrical housing may be shortened or absent, such that the entire shape is comprised of the two domes. The housing and domes further contain a bladder-type diaphragm that divides areas of a liquid and a pressurized gas. For a general discussion of expansion tanks and bladder-type diaphragms, see U.S. Pat. No. 4,784,181 to Hilverdink entitled “Expansion Tank with a Bladder-Type Diaphragm”.

In expansion tanks, it is critical to maintain a liquid and gas-tight barrier between the liquid and pressurized gas, as well as the outside environment. Any leakage between gas and liquid, or gas and outside, will cause the tank to stop working until it is recharged and may also cause permanent damage to the tank. This gas tight barrier must also be capable of flexing and bending and maintaining integrity through continuous changes in temperature and pressure, making material selection and seal joint design an integral part of overall tank performance.

Two general approaches to making this barrier have traditionally been used. For example, a first approach, as described in, among others, U.S. Pat. Nos. 7,322,488, and 7,303,091, “Expansion tank with double diaphragm”, includes a “double diaphragm bladder” secured to the interior of a tank. The bladder comprises a non-flexible diaphragm having a peripheral edge and a flexible diaphragm having a peripheral edge. The peripheral edges of the non-flexible diaphragm and the flexible diaphragm are sealed together with a ring clamp, or by heat sealing. This provides an excellent leak-proof seal. Most important in this design, the movement of the diaphragm in operation is decoupled from the outer, cylindrical housing and domes. Therefore, when the pressure differential between the water and air sections of the tank changes, and the diaphragm moves or is stretched, it does not pull on the walls of the cylinder. This approach, however has the disadvantage that it uses additional parts, including the large non-flexible diaphragm, along with corresponding additional fabrication steps, which adds both materials and manufacturing costs when compared to the second approach.

The second approach to the air-water barrier that is generally used is described in U.S. Pat. No. 7,671,754 Sensor for detecting leakage of a liquid; U.S. Pat. No. 5,368,073 Hydro pneumatic Pressure Vessel Having an Improved Diaphragm Assembly U.S. Pat. No. 5,484,079 Hydro pneumatic Filament Wound Pressure Vessel; and U.S. Pat. No. 7,216,673 Non Metallic Expansion Tank With Internal Diaphragm and Clamping Device for Same. In this design, the diaphragm is directly coupled to the outer wall of the dome or cylindrical housing by either adhesive bonding or a mechanical clamping mechanism. While this second approach has a reduced number of parts compared to the first approach that was described, attaching the diaphragm directly to the wall of the tank is a fundamentally flawed design: as the pressure differential between the water and air sections of the tank changes and the diaphragm moves and stretches, the diaphragm pulls on the attachment point to the vessel wall. It is well known by those skilled in the art that thin-walled, large diameter cylinders and spheres, are very poor in collapse conditions; by pulling inwards on the wall of the tank, it is possible to collapse portions of the tank construction. Just as importantly, it is well known by those skilled in the art that the bond strength between the dissimilar materials of construction of the tank can be very low; the force exerted by the diaphragm on the tank can cause delamination between different layers, such as the diaphragm (which is, typically, an elastomer or flexible thermoplastic), the outer wall (which is, typically, a rigid thermoplastic shell), or the fiber reinforcement (which is, typically, fiberglass in a thermoset). It can also cause interlaminar failure of the fiber reinforcement itself. So, by coupling the diaphragm directly to the wall, permanent, catastrophic failure of the tank can result.

Therefore, there is a need for a design and assembly method of an expansion tank that incorporates a single diaphragm with leak-proof seals, which minimizes the number of parts and steps in manufacturing, yet decouples the diaphragm from the cylindrical housing and domes.

### SUMMARY OF THE INVENTION

In this invention, an expansion tank with an improved diaphragm seal is provided. This expansion tank includes a seal for the joint between the flexible and non-flexible diaphragms that combines the function of both the non-flexible diaphragm and the cylindrical- and/or dome-shaped tank into a single part. This is achieved by the providing of a novel seal support, for the seal between the flexible and non-flexible diaphragms, or for the seal between the flexible diaphragm and the tank wall, in the case where there is no non-flexible diaphragm, that prevents collapse, delamination, or tearing of the tank components. This reduces the number of parts and manufacturing steps, and improves the long term performance of the tank, including under collapse conditions caused by loads from the movement of the diaphragm.

In this invention, at least one rigid or semi-rigid dome that is substantially hemispherical, or a shape that is otherwise suitable as an mandrel for the reinforcement filament winding, especially and most preferably, the winding of isotensoidal structures, is joined to a substantially cylindrical section, or directly to a second dome, or another shape that is otherwise suitable as a mandrel for filament winding, including winding of isotensoidal structures, to produce a gas-and-fluid-tight layer; this may also provide a mandrel, or form, around which fiber-reinforcement may be wound, including isotensoidal reinforcement. More generally, it is understood that isotensoidal filament winding provides the most effective structural reinforcement for thin walled tanks. The particular shapes described in this patent are those most commonly used for water tanks, but other shapes, such as toroidal shapes can also be used as isotensoidal mandrels. It must also be noted that in many situations isotensoidal filament reinforcement is not necessary, such as when operating at lower pressure differences, providing thicker, and thus stronger, tank walls or winding filaments that are not isotensoidal. This invention is effective without regard to the use of isotensoidal technology.

In accordance with this invention, one of the segments forming the thin-walled pressure tank, e.g., a dome-shaped or cylindrical section, further comprises an extension lip, extending inwardly substantially near the junction of two of the sections. This extension lip may be made from the same material as the tank, e.g., dome-shaped or cylindrical tank segment, or may be part of a separate circumferential connector interconnecting two of the sections of the tank wall. The extension lip provides a joining surface on which the flexible diaphragm can be sealably connected to a nonflexible diaphragm, or if there is only one diaphragm, directly to the tank wall; the sealing connection is achieved by techniques known to those skilled in the art, such as adhesive bonding, solvent welding, thermal welding, clamping or the like, or by similar techniques that may be developed in the future. Critical to this design, the extension lip is of sufficient length and modulus of elasticity, so that when the diaphragm is stretched, and thus pulls against the lip, the extension lip deflects without substantially affecting the body of the tank. This deflection allows the diaphragm's collapse load to be substantially decoupled from the tank outer wall, e.g., of the dome- or cylindrical-shaped section of the tank.

In another preferred embodiment, the lip is formed as part of a substantially stiff clinch ring which may be connected between two of the tank segments, e.g., between the cylindrical wall and a dome, of the outer tank wall, or to the interior surface of one of the sections, or overlapping the two sections, e.g., cylindrical and dome-shaped, and their junction line. The latter can provide additional structural support to the tank, or additional rigidity to the end of the extension lip, to further prevent structural collapse of the outer tank walls as a result of stress from the diaphragm, in either its expanded or collapsed conditions, by further isolating the tank walls from the diaphragm movements. The lip is preferably circumferential, extending inwardly from the clinch ring circumference, or from the wall surface, and is sealingly joined to the flexible diaphragm by any known means. In another embodiment, a portion of the length of the lip can be formed having a thinner cross-section, so as to allow for deflection of the lip at lower stresses from the diaphragm.

Critical to these designs, the deflectable extension lip forming the seal for the diaphragms, is connected to, but substantially mechanically and structurally decoupled from, the dome-and/or-cylinder-shaped tank, or mandrel, for forming the tank body.

### BRIEF DESCRIPTION OF THE DRAWING

The invention is described with reference to the several figures of the drawing, in which,

FIG. 1 is a schematic cross-section of a diaphragm tank according to an embodiment of the invention, representing the tank charged with air pressure and the space below flexible diaphragm being empty of water;

FIG. 1A is an expanded partial view of the schematic cross-section of the diaphragm tank of FIG. 1;

FIG. 2 is a schematic cross-section of a diaphragm tank according to an embodiment of the invention representing the tank charged with air pressure and the space below the flexible diaphragm being filled with water;

FIG. 3 is a photograph of a cutaway portion of the tank manufactured in accordance with the invention;

FIG. 4 is a is a schematic cross-section view of a diaphragm tank according to an embodiment of the invention representing a tank made with a stepped extension lip;

FIG. 5 is a schematic cross-section view of a diaphragm tank according to another embodiment of the invention representing a tank made with a substantially short cylinder and angled extension lip;

FIG. 6 is a schematic cross-section view of a diaphragm tank according to another embodiment of the invention representing a tank with the extension lip integral to a dome-shaped segment;

FIG. 7 is a schematic cross-section view of a diaphragm tank according to another embodiment of the invention representing a tank with an extension lip that has zero draft;

FIG. 7B is an expanded, schematic cross-section partial view of the diaphragm tank of FIG. 7, showing a detail of the extension lip;

FIG. 8 is a schematic cross-section view of a diaphragm tank according to another embodiment of the invention representing a tank with a stepped extension lip and bump out; and

FIG. 8B is an expanded, schematic cross-section partial view of the diaphragm tank of FIG. 8, showing a detail of the extension lip and bump out.

### DETAILED DESCRIPTION OF CERTAIN PREFERRED EMBODIMENTS

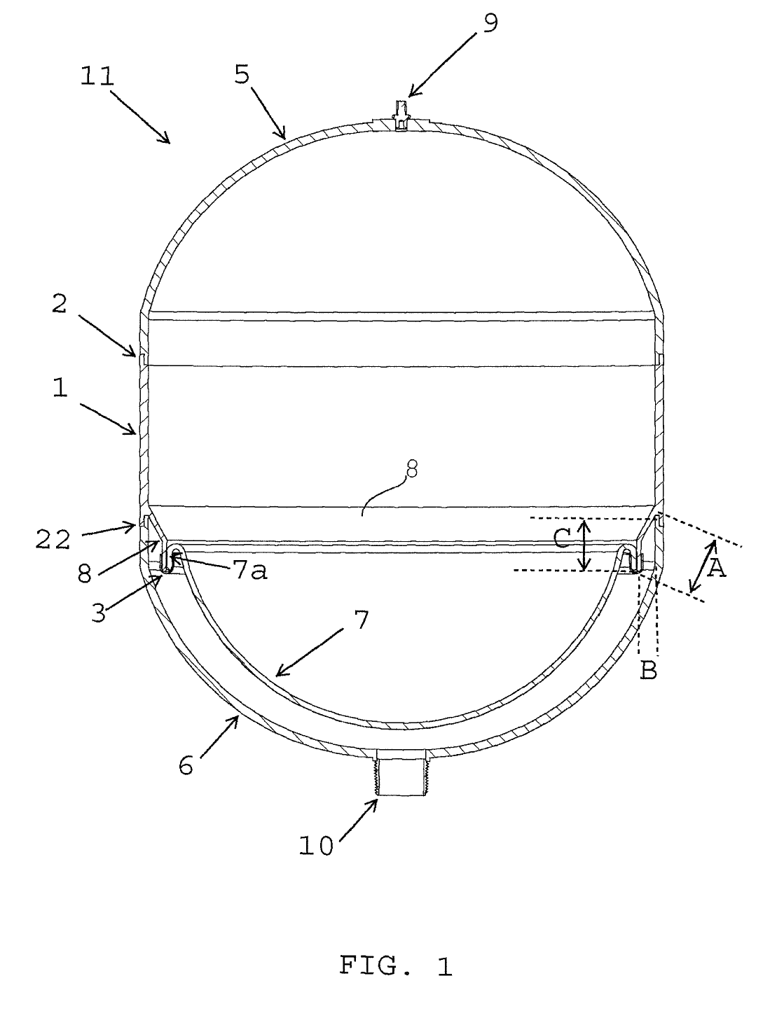

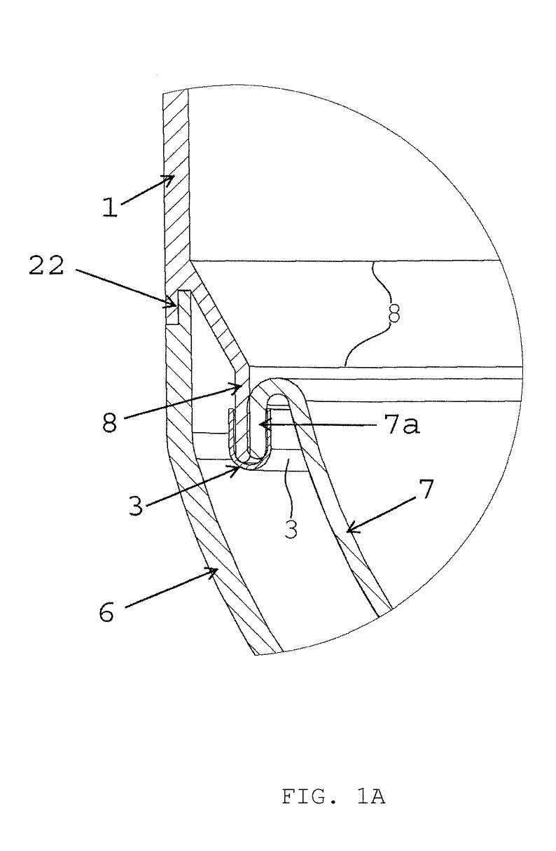

FIGS. 1 and 1A are cross sections of a tank 11, with a decoupled single flexible diaphragm 7. The upper portion of the tank, above the diaphragm 7, is charged with air through the nipple 9, but the lower portion, under the diaphragm 7, is empty of water. The tank comprises a central, substantially cylindrical housing section 1, joined at two circumferential locations 2 and 22 to dome-shaped sections 5 and 6, respectively. The overall tank 11, preferably forms a substantially isotensoidal shape. Extending inwardly from the central cylindrical tank section 1, from a location closely adjacent to the lower joint 22, is a circumferential locking lip 8. A flexible diaphragm 7 is held within the tank 5 by being secured to the locking lip 8. The peripheral edge 7a of the diaphragm 7 is secured to the extension lip 8 through a circumferentially extending crimp ring 3. The dome-shaped section 5 further comprises an air valve and nipple 9, which allows one area of the tank to be charged with air or gas. The lower dome-shaped section 6 further comprises a threaded connection 10 through which water can flow.

In certain embodiments, the tank sections and items 1, 3, 5, 6, 8 may be independently, or together formed of non-metallic materials, selected from the group including thermoplastic polymers, thermoset polymers, whether plastic or elastomeric, natural rubbers, or multilayer materials comprising the same.

In certain embodiments, the tank segments and items 1, 3, 5, 6, 8 may be formed of materials selected from a group of thermoplastics including polyolefins, polyethylene, polypropylene, polybutylene, nylon, PVC, CPVC, ionomers, fluoropolymers, copolymers, crosslinked polyolefins such as crosslinked polyethylene (PEX, PEX-a. PEX-b, PEX-c or XLPE), or multilayer structures comprising the same. The individual items forming the above-described tank: 1, 3, 5, 6, 8 may also include a “tie-layer”. A “tie layer” is usually one or a combination of two or more mutually compatible materials that form a bonding layer between two mutually incompatible materials. Tie layers may include, for example, a thermoplastic material that provides adhesion to two adjacent materials, most often through melt processing or chemical reactions; modified acrylic acid, or anhydride grafted polymers or those similar to but not limited to DuPont's Bynel, Nucrel, and Fusabond grades, or those described and referenced, as further examples, in U.S. Pat. Nos. 8,076,000, 7,807,013 and 7,285,333. The melting point or melt index of the tie layer may be selected so that the tie-layer can be post-processed without substantially melting or flowing other non-metallics in the structure.

In some embodiments, 1, 3, 5, 6, 8 may be filled polymers or comprise solids such as but not limited to particles or flakes of polymers or minerals including glass, talc, carbon and graphite; chopped fibers, discontinuous fibers, short or long fibers, or continuous fibers of polymers or minerals including glass or carbon; nanocomposites; clays; or other fibers, particles, flakes or hollow microspheres. In some embodiments, 1, 3, 5, 6, 8 are independently or together metals, such as but not limited to steels, stainless steels, aluminum, or the like. In some cases 5 and 6 may further comprise fittings or valves, including those made of metals or non-metals, including but not limited to threaded fittings, compression fittings, bulkhead fittings, quick-disconnect fittings, clip or crimp fittings, air valves, ball valves, needle valves or the like. In some cases, 5 and 6 may provide surfaces on which to make additional connections through processes including but not limited to stick welding, butt welding, spin welding, friction stir welding, ultrasonic welding, induction welding, solvent welding, RF/microwave processing, resistance-based fusion, adhesives, tie layers, or the like. These fittings, valves, or other surfaces may be connected by means known to those skilled in the art to additional system components including, but not limited to, heaters, filters, pumps, pipes, tanks, or hoses. As an example, dome 5 comprises an air valve 9 and dome 6 comprises a threaded water connection.

In certain preferred embodiments, 1, 3, 5, 6, 8 are polypropylene, ethylene-polypropylene copolymers, and glass particle or glass fiber-filled polypropylene and ethylene-polypropylene copolymers. The ethylene-propylene copolymers may be block copolymers. The melting point and melt index of items 1, 3, 5, 6, 8 may be tailored to improve the assembly and processing of the tank. In certain embodiments, the outer surface of 1, 3, 5, 6, and 8 may be independently or together surface modified by high energy treatments including ion implantation, plasma, corona or arc to improve adhesion to adjacent materials. The inner surface of 1, 3, 5, 6, 8 can also be modified to change properties, such as, but not limited to, chemical resistance, permeability, and wettability by water. Treatments may include but not limited to fluorination or the technologies employed by NBD Nano, or by metallization through chemical vapor deposition or the like. In certain preferred embodiments, polypropylene, polypropylene copolymers, glass filled polypropylene and glass filled polypropylene copolymers are treated by a flame to improve adhesion to adjacent layers. In some preferred embodiments, 1, 3, 5, 6, 8 may include antimicrobials, including antifungals, antivirals, or antibiotics, or comprise silver. In other preferred embodiments, 1, 3, 5, 6, 8 contain antioxidants and stabilizers.

The diaphragm 7 may be comprised of a polymer, elastomer, rubber, RTV, or thermoplastic, or multiple layers compromising the same. In certain preferred embodiments, the diaphragm 7 comprises butyl rubber or EPDM. In other embodiments, the diaphragm may be filled with solids such as but not limited to particles or flakes of polymers or minerals including glass, talc, carbon and graphite; chopped fibers, discontinuous fibers, short or long fibers, or continuous fibers of polymers or minerals including glass or carbon; nanocomposites; clays; or other fibers, particles, flakes or hollow microspheres; or woven or non-woven fabrics; to improve the thermomechanical properties or decrease permeability of gases through the membrane. In some embodiments, these multiple layers of the diaphragm are bonded, but the layers may also be non-bonded. In certain embodiments, the layers include a thin higher modulus layer supported by a thicker, lower modulus layer. The high modulus layer may be selected from chemically resistant polymers, or polymers preferred for contact with potable water, such as polypropylene, polyethylene, polybutylene, or the like. The low modulus layer may be selected for different properties, such as durability, toughness, and low cost, protected from contact with the potable water by the high modulus layer.

The diaphragm 7 may also comprise features to reduce the tendency of the diaphragm to wear or become fatigued in service, or protect it from abrasion or cutting by adjacent structures such as a clinch ring. In some cases, the diaphragm 7 may be of substantially non-uniform thickness or modulus. The non-uniform thickness or modulus may be controlled across the surface to reduce the tendency for the diaphragm to rub against itself, against other structures, abrade or tear. The diaphragm 7 can also be substantially folded, in an accordion, serpentine, or wavy shape. These shapes may allow for more compact or rigid diaphragms to be used, while still allowing extension in service without localized strains exceeding the limits of the materials. The diaphragm may be further molded or installed in the shape or orientation that it is most often in service to reduce the in-situ strains or abrasion.

The diaphragm 7 can be sealably joined at the peripheral edge 7a to the lip 8 by methods known to those skilled in the art. Such sealable joints can be formed using, for example, adhesives, solvent bonding, stick welding, butt welding, spin welding, friction stir welding, induction welding, RF/microwave processing, resistance-based fusion, tie layers, or the like, with or without additional sealants. In certain preferred embodiments, the connection of the extension lip 8 and the diaphragm 7 may also be made by the application of a rigid clinch ring 3. Such a ring 3 can be comprised of metal or non-metal and provides a clamping force by means known to those skilled in the art, such as but not limited to crimping, snap coupling, fasteners, adhesives, melt processing, thermoforming or the like. The connection between ring 3, the diaphragm 7 and the lip 8 is accomplished by the use of features or structures that improve the connection and seal to the lip 8 such as lips, dimples, ridges, knobs, integral rings, including multiple rings.

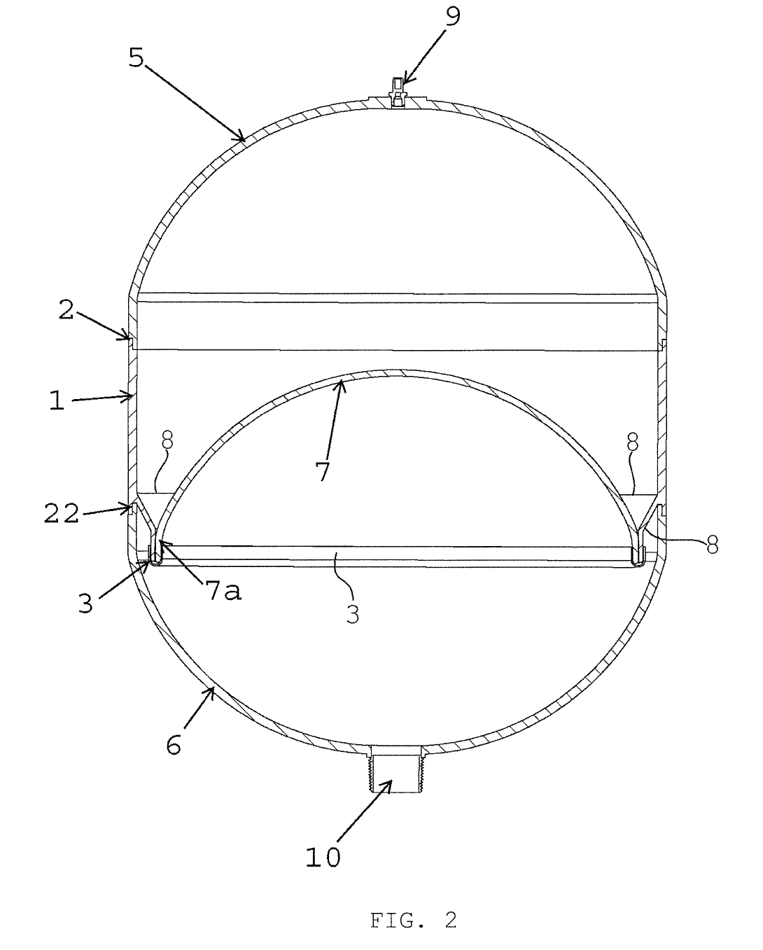

In certain preferred embodiments, the diaphragm 7 may extend over both sides of the end of the lip 8 and/or be gripped between the surfaces of a u-shaped ring 3 against the surfaces of the lip 8, as shown for example in the drawings of FIGS. 1 and 2. In some cases, the clinch ring 3 may have a contour that controls the radius of curvature of the diaphragm and protects the diaphragm from contacting any sharp edges. The ring 3 may further provide collapse resistance but this may not be needed due to the novel design of the extension lip 8.

In some embodiments, the materials forming sections of the assembled tank, assembly 1-10 may be further reinforced to increase the pressure carrying capabilities of the expansion tank. This reinforcement may comprise glass (including but not limited to borosilicate, e-, s-, and cr-glass), basalt, quartz, carbon or other inorganic or mineral fibers. The reinforcement may also comprise organic or inorganic polymer fibers such as but not limited to polyester, nylon, polypropylene, Kevlar, Nomex, PPS or carbon. These fibers or fillers may be continuous or discontinuous fibers, chopped, non-wovens or random oriented mat, or may be in the form of fiber tapes. The reinforcing materials may be in a thermoset or thermoplastic matrix, or present without a matrix. In certain preferred embodiments, the reinforcement is a fiberglass-reinforced epoxy. For purposes of clarity, the reinforcement has not been shown on the outside of the tank in each Figure, but reinforcement of pressure vessels by, for example, filament winding is well known to those skilled in the art. In some cases, the reinforcement is a metal such as but not limited to steels, stainless steels, aluminum or the like.

Critical to the operation of this diaphragm tank are the properties of the novel extension lip, 8, that seals the peripheral edge 7a of the single flexible diaphragm 7, but mechanically decouples it from the tank walls formed from the domes 5, 6 as well as the cylindrical housing 1, as well as joints 2 and 22. It has been found, as part of this invention, that the dimensions and thermomechanical properties of the extension lip are preferably selected within critical ranges to allow for the fabrication of the housing 1, the diaphragm 7, and the domes 5, and 6, and the overall assembly of the finished tank, while also substantially decoupling the mechanical forces acting upon the clamping ring 3, and the extension lip 8, from significantly transferring to the rest of the tank, especially to the three main tank sections 1, 5 or 6, as well as joints 2 and 22. Allowable ranges for the dimensions and thermomechanical properties of the extension lip, 8, are provided in Table 1, below.

TABLE 1
functional ranges of dimensions and thermomechanical properties
of extension lip 8 and preferred embodiments.

| | | | Preferred |
|---|---|---|---|
| Parameter | Unit | Allowable Range | Embodiment |
| Length (A) | Inch | 0.1 to 6 | 1.5 |
| Average Thickness | Inch | 0.04 to 0.5 | 0.1 |
| Space between dome | Inch | 0 to 2 | 0.25 |
| or cylinder & lip | | | |
| 8 (B) | | | |
| Distance of lip 8 past | Inch | −4 to 4 | 1 |
| start of dome 6 (C) | | | |
| Tensile Modulus of | KSI | 5-500 | 250 |
| lip 8 | | | |
| Flexural Modulus of | KSI | 4-500 | 200 |
| lip 8 | | | |
| Yield Strain of lip 8 | % | >1 | 10 |
| Tensile strength of | KSI | >0.5 | 4 |
| lip 8 at yield | | | |
| Heat Deflection | F. | >80 | 190 |
| Temperature | | | |

The inventors have found that in certain embodiments, the length A of the lip 8 should be between 0.5 and 4 inches, or 0.1 and 1 inches, or 4 and 6 inches.

The inventors have also found that it is possible to build a functional decoupled single diaphragm expansion tank where the tank sections, e.g., the cylindrical section and the two dome-shaped end sections 1, 5, and 6 may be metal and 8 is metal or non-metal.

By selecting dimensions and thermomechanical properties for the extension lip 8 within these ranges, it is possible to reduce or decouple the forces that diaphragm 7 exerts on the sections of the tank structure 1, 5, and 6 by 50% to as much as 95% or more. Therefore, as the air or water pressure changes within the tank, and the diaphragm is deflected, pulled, or stretched, the force of the diaphragm is functionally decoupled or isolated from the rest of the tank. For example, FIG. 2 shows the same tank after the lower section has been charged with water, driving the flexible diaphragm 7 upwards. As the pressure differential between the water and air sections changes, and the diaphragm moves and is stretched, the diaphragm does not significantly pull on the walls of the cylinder, exert collapse forces, cause debonding, delamination or interlaminar failure as is known in other single diaphragm tanks described earlier, due to the novel extension lip 8, which is tailored to bend or stretch before the stress from the diaphragm is sufficient to cause any damage to the tank wall.

It is known to one skilled in the art that the relative volume of the gas and liquid sections of the tank will change depending on the pressure of the air (or other gas), or as is more common in practice, the pressure of the water. In certain preferred embodiments, the volume of the tank filled with air at equilibrium, balanced conditions are roughly 1 to 3 times the volume of the water, or 0.5 to 1 times. In other embodiments, it can be 0.1-10 times.

In contrast to the double diaphragm tanks described previously, this single diaphragm can be assembled by a reduced number of parts and operations, reducing the overall tank cost. The major sections of the tank, the cylindrical central section 1, and the dome-shaped end sections 5 and 6 can be joined by means known to those skilled in the art including butt welding, spin welding, ultrasonic welding, RF welding, microwave welding, induction welding, friction stir welding, stick welding, resistance heating, solvent welding, contact adhesives, chemical bonding, tie layers, or the like, with or without additional sealants. The design of the joints 2 and 2s2, between these three major tank sections 1, 5, and 6, can be independently selected from designs known to those skilled in the art. For example, while shown in FIG. 1 as a lap joint, it may also be, but not limited to, a double lap, tongue-and groove, v-groove, face, tapered, overlap, or the like. In some embodiments, the rings 3 or 8 may help provide alignment, centralization and circularization of the major sections 1, 5, 6 when joining the parts. In certain embodiments, the ring 3 may also be bonded to 1, 5, 6, 7, or 7a.

Although the clinch ring and extension lip are shown as continuous circumferential shapes, it is understood that the extension lip can be a series of discontinuous extensions located at alternating positions around the circumference of the clinch ring. This may not provide the same degree of a pressure seal as a continuous ring, but may be more successfully decoupled structurally from the tank structure when the internal parts 3, 7, 8 move.

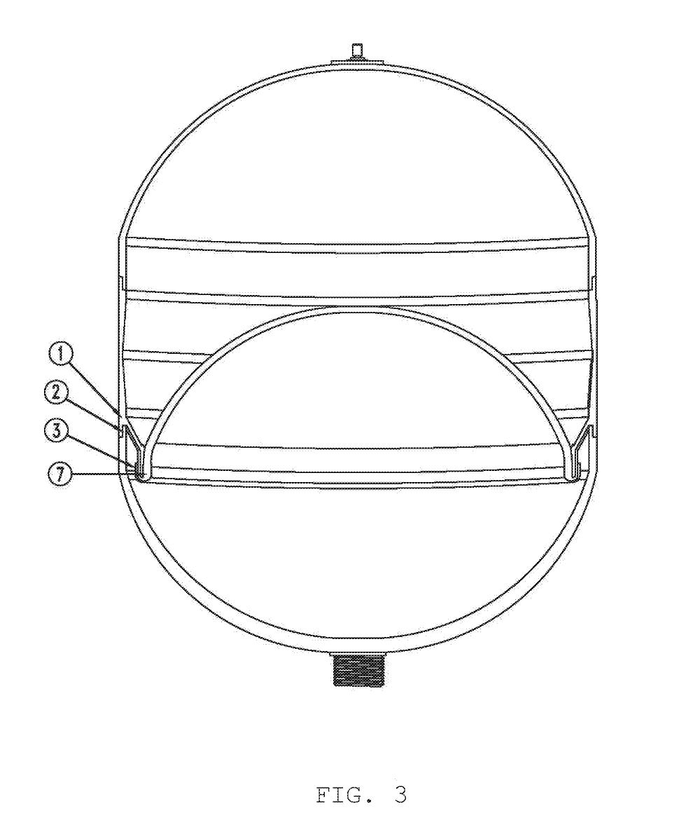

In a preferred embodiment of the assembly, the diaphragm 7 can be secured to the tank cylindrical section through the extension lip 8 by being wrapped over the end of the extension lip 8 and compressed using a crimp ring 3. The assembly of the cylindrical section 1 to the dome-shaped end sections 5, 6 is then completed, for example, by spin welding lap joints. Any external weld bead is then ground off. The tank is then flame treated for subsequent adhesion to a fiberglass-epoxy reinforcement winding. A photograph of a cross section of this preferred embodiment prior to reinforcement is shown in FIG. 3.

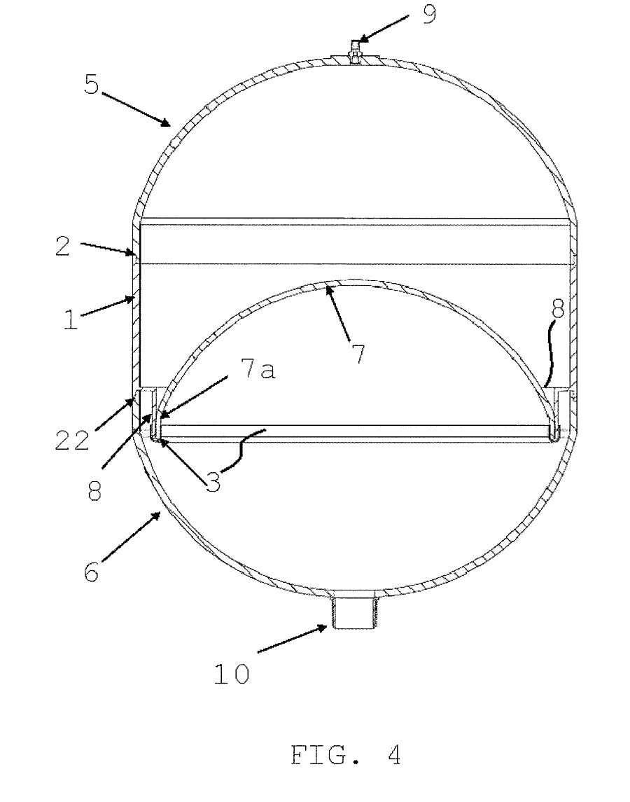

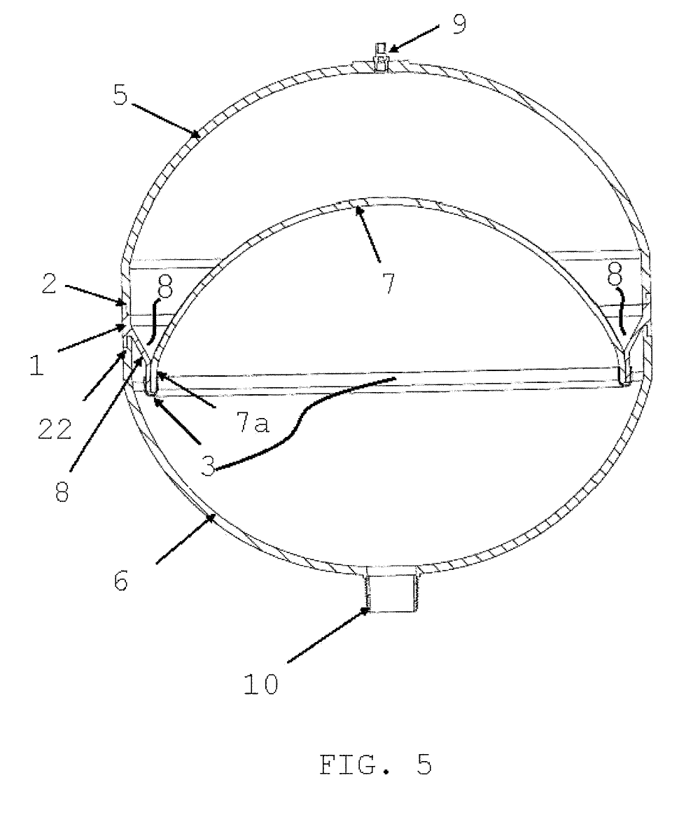

It should be obvious to one skilled in the art that there are a number of different procedures that can be followed to design, manufacture, and assemble a diaphragm tank with the single decoupled diaphragm. For example, FIG. 4 shows an extension lip 8 that is formed in a step shape, i.e., offset at a 90° angle. FIG. 5 shows an extension lip 8 that is coupled to a cylindrical section 1 that is substantially shorter so as to form a substantially spherical tank. Similarly, the extension lip can be joined to the domes 5, 6 rather than the cylinder 1.

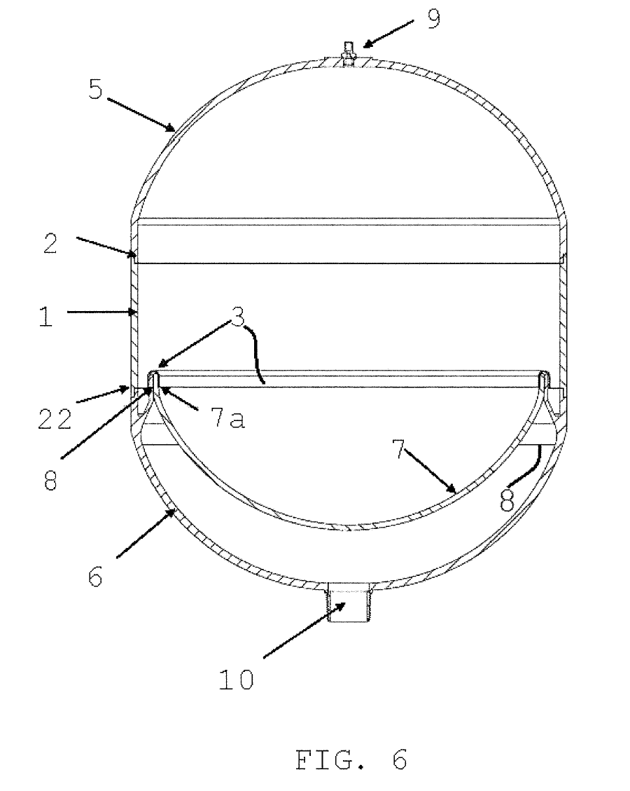

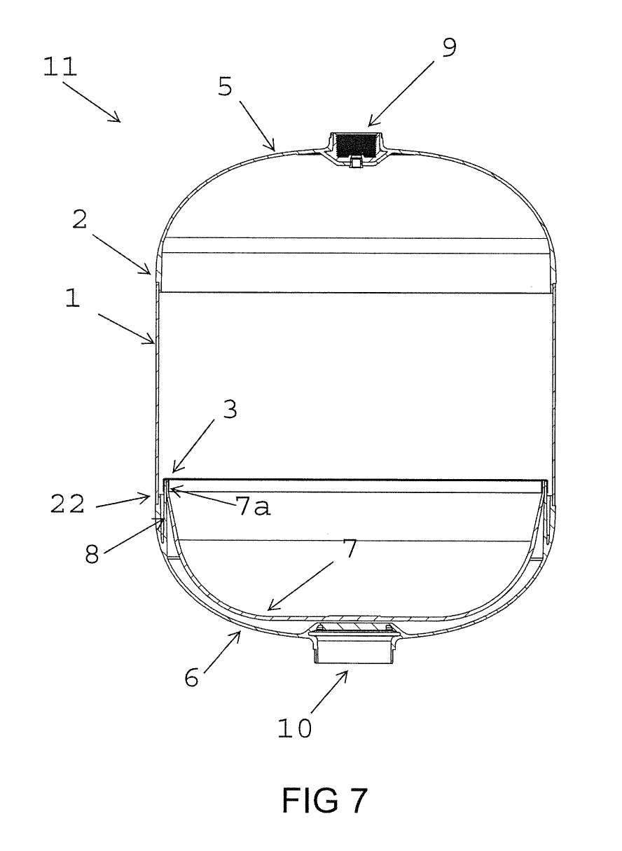

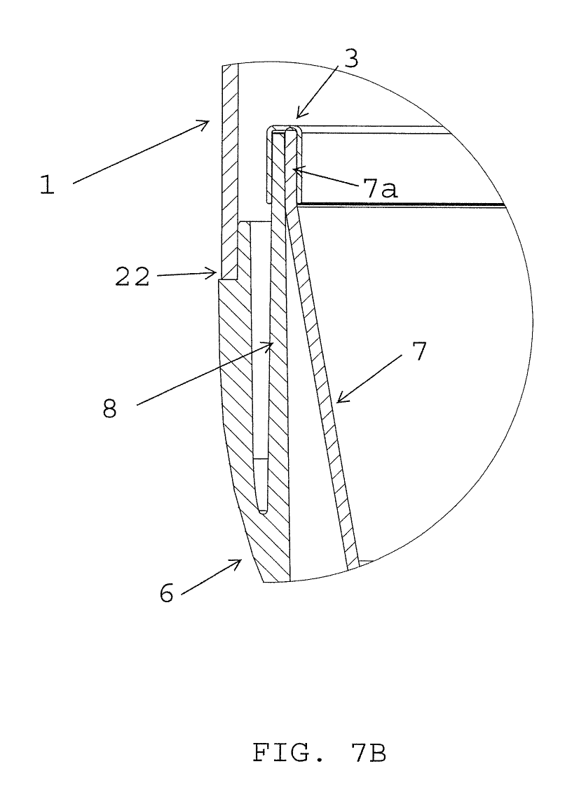

FIG. 6 depicts an extension lip 8 that is integral to the lower dome section 6. FIG. 7 and FIG. 7B also depict an extension lip, 8, that is integral to the lower dome, 6, that may be easier to manufacture by injection molding, because there is zero draft. This allows the dome 6 and the lip 8 to be pulled from the mold without having to collapse the inner mold.

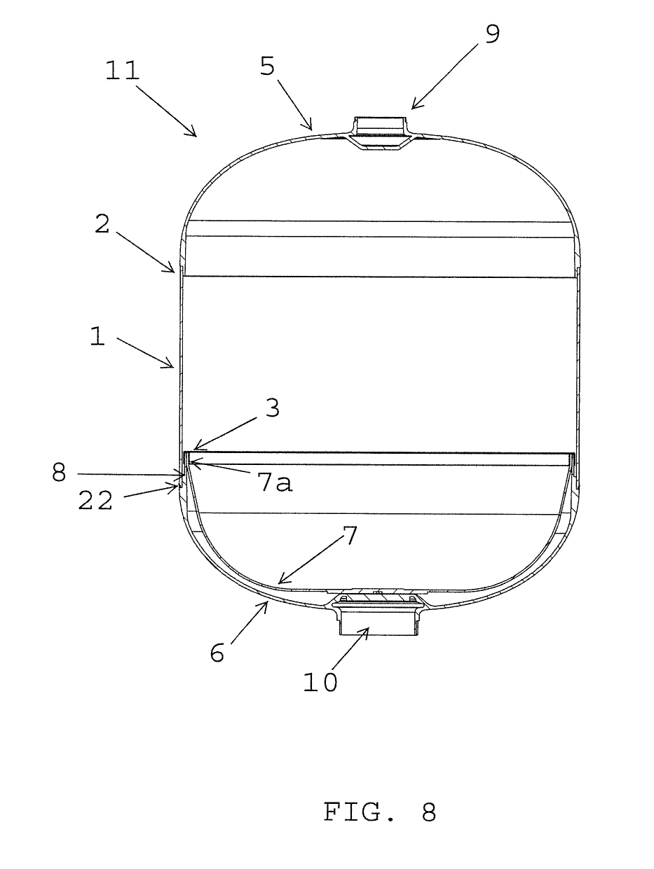

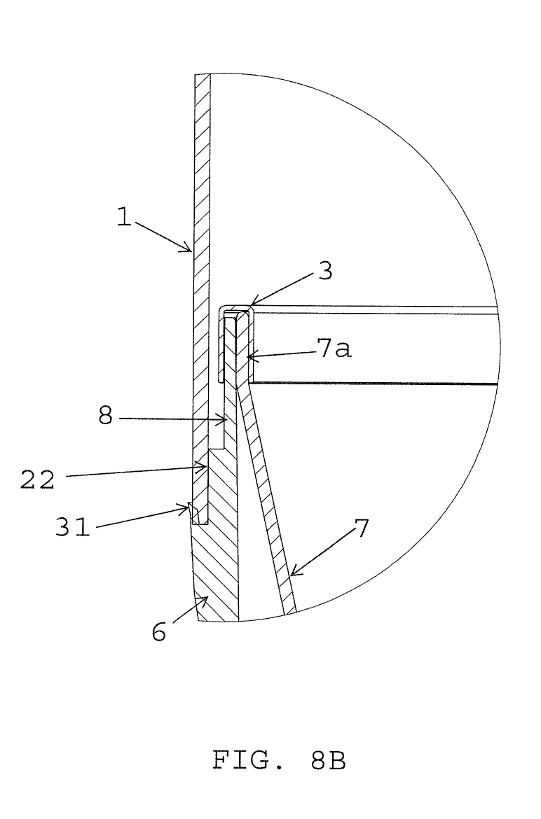

FIG. 8 and FIG. 8B depicts another embodiment of the extension lip 8, that is molded with the lower dome 6, with zero draft together with an exterior bump out 31, that guides the cylinder 1, into a groove for spin welding. This bump out 31 allows for increased axial force during the welding while preventing the liner of the cylinder section 1 from jumping over the peripheral edge of the dome 6. The bump out 31 may help provide more consistent normal forces in the lapped portion of the joint 22 with manufacturing variations in the cylinder 1 and dome 6, by setting a fixed distance in the groove formed between the bump out 31 and the contacting surfaces of the lapped joint 22. The bump out 31 may be ground off after spin welding to provide a smooth outer surface for the completed tank.

The extension lip 8 may also be oriented to minimize the strain on the diaphragm under the most prevalent position of the diaphragm in operation, or the most extreme conditions, or the conditions that would otherwise result in failure of the diaphragm. By way of example, the extension lip 8 in FIG. 1 is oriented such that if the water section is filled and pressurized, as shown in FIG. 2, there are reduced strains near 7a, between the lip 8 and the clinch ring 3. In any design, the lip 8 can also be positioned substantially on the same horizon with the lapped joint 2, or it may be positioned substantially inside the cylinder 1, or substantially inside dome 5 or 6. In some tank designs, it may be beneficial to have two or more diaphragms, with one or more diaphragms connected through an extension lip. In some tank designs, it might be desired to fabricate the cylindrical portion of the tank by stacking and joining multiple open-ended cylinders, one or more of which may have an extension lip.

The several sections of the tanks of this invention 1, 5, 6, 7, 8, may be fabricated by means known to those skilled in the art, including but not limited to extrusion, injection molding, over molding, thermoforming, or the like, and may each be assembled from individual parts by means known to those skilled in the art such as but not limited to butt welding, spin welding, ultrasonic welding, RF welding, induction welding, microwave welding, induction welding, friction stir welding, stick welding, resistance heating, solvent welding, contact adhesives, chemical bonding, tie layers, or the like, with or without additional sealants.

It may be beneficial to form the lip extension 8 with a smaller diameter than the rest of the dome 5, 6, or the cylinder 1, so that it may be easily inserted. To form a dome with an integral lip extension of smaller diameter, a collapsing mold core may be used. Alternatively, the shrinkage of the lip extension 8 during cooling can be controlled such that the lip extension 8 contracts to a smaller diameter than the rest of the dome. Alternatively, the diameter of 8 may be reduced by pressure forming or thermoforming.

In certain preferred embodiments, the design of the dome with an integral extension lip has no features that are oriented towards the center of the tank so as to allow the dome with integral extension lip to be manufactured by injection molding in a standard two-piece mold. In some embodiments, it may be beneficial to use gas injection during the molding to maintain relatively constant material thicknesses along the molded part. Alternatively, the lip extension 8 may be fabricated as a separate part and welded onto one of the major tank sections 1, 5, or 6 by means known to those skilled in the art including but not limited to butt welding, spin welding, ultrasonic welding, RF welding, microwave welding, induction welding, friction stir welding, stick welding, resistance heating, butt welding, solvent welding, contact adhesives, chemical bonding, tie layers, or the like, with or without additional sealants. This approach is a particularly useful means to incorporate an extension lip into an extruded cylinder 1.

It would also be obvious to one skilled in the art that there are a number of possible ways to fabricate and assemble the parts depending on material selection, geometry, and available equipment.

What is claimed is:

1. In an expansion tank for at least temporarily storing a pumped liquid under pressure, the expansion tank comprising a thin walled outer shell formed of two substantially hemispherical domes joined together, either directly or at the two ends of a central, substantially cylindrical section, and a flexible diaphragm located internally of the tank and secured to the inner surface of the shell of the tank to divide the internal volume of the tank into a fluid-tight section holding a gas under pressure and a fluid-tight section for holding an aqueous liquid under pressure; the improvement comprising an improved fluid tight connection between the diaphragm and the inner surface of the outer shell of the tank, the connection comprising a circumferential joining lip extending inwardly from, and sealingly connected at its diametric outer edge to the inner surface of the outer tank wall, and at its diametric innermost area to the peripheral lip of the flexible diaphragm; the relationship of the distance from the tank wall of the diametric inner joining lip surface sealed to the diaphragm and the modulus of elasticity of the joining lip is such that any stress applied by the flexible diaphragm as it responds to changes in the relative gas and liquid pressures to which it is subjected, will cause the lip to deflect without affecting the outer tank wall, thus effectively decoupling the flexible diaphragm load from the potentially sensitive outer tank.

2. The expansion tank of claim 1 wherein the thin walled outer shell is isotensoidally reinforced.

3. The expansion tank of claim 2 wherein the expansion tank comprises a thin walled outer shell formed of two substantially hemispherical domes directly joined together.

4. The expansion tank of claim 2, wherein the expansion tank is extended and further comprises a thin walled outer shell formed of two substantially hemispherical domes joined together at the two ends of a central, substantially cylindrical section.

5. The expansion tank of claim 2 further comprising a nonflexible concave diaphragm, opening towards the flexible diaphragm and connected to a diametrically outer most portion of the joining lip.

6. The expansion tank of claim 3, wherein the joining lip has a length from the outer tank wall of from 0.1 to 6 inches; a thickness in the range of 0.04 to 0.5 in., the distance along a diameter of the end of the lip from the inner surface of the outer tank wall, of up to 2 ins., the projected length of the lip along the tank wall: up to 4 ins., the tensile modulus of the lip 5-500 KSI, flexural modulus of the lip: 4-500 KSI; the yield strain of the lip is greater than 1%; the tensile strength of the lip at yield is greater than 0.5 KSI and the heat deflection temperature of the lip is greater than 80° F.

7. The expansion tank of claim 3, wherein the joining lip has a length from the outer tank wall of from 1.2 to 1.8 inches; a thickness in the range of 0.08 to 0.15 in.; the distance along a diameter of the end of the lip from the inner surface of the outer tank wall, of from 0.2 to 0.52 ins.; the projected length of the lip along the tank wall: from 0.8 to 1.5 ins., the tensile modulus of the lip: 150-300 KSI, flexural modulus of the lip: from 180-250 KSI; the yield strain of the lip is 8% to 15%; the tensile strength of the lip at yield is greater than 3-5 KSI; and the heat deflection temperature of the lip is 150-250° F.
